(19) United States
(12) Patent Application Publication
(10) Pub. No.: US 2016/0028584 A1
(43) Pub. Date: Jan. 28, 2016

(54) ELECTRONIC DEVICE AND IMS SERVICE PROVIDING METHOD THEREOF

(71) Applicant: Samsung Electronics Co., Ltd., Gyeonggi-do (KR)

(72) Inventors: Jin Suk LEE, Gyeonggi-do (KR); Sun Min Hwang, Gyeonggi-do (KR)

(73) Assignee: Samsung Electronics Co., Ltd.

(21) Appl. No.: 14/811,375

(22) Filed: Jul. 28, 2015

(30) Foreign Application Priority Data
Jul. 28, 2014 (KR) 10-2014-0095851

(51) Int. Cl. H04L 12/24; H04L 29/06

(52) U.S. Cl. CPC H04L 41/0806; H04L 69/08

(57) ABSTRACT

An internet protocol (IP) multimedia subsystem (IMS) service providing method of a main electronic device and the main electronic device are provided. The main electronic device includes a first communication module configured to communicate with a sub electronic device; a second communication module configured to communicate with an internet protocol (IP) multimedia subsystem (IMS) server; and a control module configured to control receipt of IMS registration information from the sub electronic device and registration of the sub electronic device in the IMS server by using at least some of the received IMS registration information of the sub electronic device.

### PRIORITY

This application claims priority under 35 U.S.C. §119(a) to Korean Patent Application Serial No. 10-2014-0095851 filed in the Korean Intellectual Property Office on Jul. 28, 2014, the entire content of which is incorporated herein by reference.

### BACKGROUND

1. Field of the Invention

The present disclosure relates generally to providing an internet protocol (IP) multimedia subsystem (IMS) service, and more specifically to an electronic device capable of using an IMS service in interoperation with an IMS server, and an IMS service providing method thereof.

2. Description of the Related Art

IMS is a standard for providing multimedia services such as voice, video, and data on the basis of internet protocol (IP). IMS uses universal internet based technologies and standardized network functions so that service price competitiveness improvements and rapid service developments and changes are possible.

Recently, with portable electronic devices, such as smartphones, the use of IMS service has increased. In addition, technologies relating to wearable electronic devices that interoperate with portable electronic devices are being developed.

Some wearable electronic devices do not embed IMS stacks therein, due to their impact on hardware performance. However even if IMS stacks are embedded in wearable electronic devices, there are limitations in using IMS service separately from other portable electronic devices, due to the battery consumption required by wearable electronic devices for such operations.

### SUMMARY

Accordingly, an aspect of the present invention is to provide a main electronic device allowing the IMS service use of a wearable electronic device connected via network and an IMS service providing method thereof.

In accordance with an aspect of the present invention, a main electronic device is provided. The main electronic device includes a first communication module configured to communicate with a sub electronic device; a second communication module configured to communicate with an internet protocol (IP) multimedia subsystem (IMS) server; and a control module configured to control receipt of IMS registration information from the sub electronic device and registration of the sub electronic device in the IMS server by using at least some of the received IMS registration information of the sub electronic device.

In accordance with another aspect of the present invention, provided is an internet protocol (IP) multimedia subsystem (IMS) service providing method of a main electronic device is provided. The method includes receiving, from a sub electronic device, IMS registration information of the sub electronic device; and registering, in an IMS server, the sub electronic device by using at least some of the received IMS registration information of the sub electronic device.

In accordance with another aspect of the present invention, a non-transitory computer readable recording medium has a program thereon to execute an internet protocol (IP) multimedia subsystem (IMS) service providing method of a main electronic device is provided. The method includes receiving IMS registration information of a sub electronic device from the sub electronic device and registering the sub electronic device in an IMS server by using at least some of the IMS registration information of the sub electronic device.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a diagram illustrating a configuration of an IP multimedia subsystem (IMS) system according to an embodiment of the present invention.

FIGS. 2 to 5 are diagrams illustrating an IMS service providing method of an IMS system according to an embodiment of the present invention.

FIG. 6 is a block diagram illustrating a configuration of a main electronic device according to an embodiment of the present invention.

FIG. 7 is a flowchart illustrating an IMS service providing method of a main electronic device according to an embodiment of the present invention.

### DETAILED DESCRIPTION OF EMBODIMENTS OF THE INVENTION

Hereinafter, various embodiments of the present invention are described as follows with reference to the accompanying drawings. Various modifications may be performed with respect to various embodiments of the present invention. Although specific embodiments of the present invention are illustrated in drawings and related detailed descriptions are listed, these references to specific embodiments do not limit various embodiments of the present invention to specific embodiments. The present invention covers all the modifications, equivalents, and/or replacements of embodiments of the present invention. With respect to descriptions of the accompanying drawings herein, like reference numerals may refer to the same or similar elements.

Herein, the terms “include,” “comprise,” and “have”, or “may include,” or “may comprise” and “may have”, as used herein, indicate disclosed functions, operations, or existence of elements, but do not exclude other functions, operations or elements. Additionally, throughout the following description of various embodiments of the present invention, the term “include,” “comprise,” “including,” or “comprising,” specifies a property, a region, a fixed number, a step, a process, an element and/or a component but does not exclude other properties, regions, fixed numbers, steps, processes, elements and/or components.

According to various embodiments of the present invention, expressions such as “A or B”, “A and/or B”, or “at least one of A and B” may include all possible combinations of items listed together. For instance, the expression “A or B”, “A and/or B” or “at least one of A and B” may indicate include A, B, or both A and B.

The terms such as “1st”, “2nd”, “first”, “second”, and the like used herein may refer to identifying various different elements of an embodiment of the present invention, but do not limit the elements. For instance, such expressions do not limit the order and/or importance of corresponding components. The expressions may be used to distinguish one element from another element. For instance, “a first user device” and “a second user device” each indicate a different user device. For example, a first component may be referred to as a second component and vice versa without departing from the scope of embodiments of the present invention.

In following description, when one part (or element, device, etc.) is referred to as being “connected” to another part (or element, device, etc.), the former can be “directly connected” to the latter, or “connected” to the latter via an intervening part (or element, device, etc.). In contrast, when an element is referred to as being “directly connected” or “directly coupled” to another element, there are no intervening elements present.

In various embodiments of the present invention, terms used herein describe specific embodiments, and are not intended to limit the scope of embodiments of the present invention. The terms of a singular form may include plural forms unless terms have a clearly different definition in the context in which the terms are used.

Unless otherwise indicated herein, all the terms used herein, which include technical or scientific terms, may have the same definition that is generally understood by a person skilled in the art.

In general, terms defined in a dictionary should be considered to have the same definition as a contextual definition according to the related art, and, unless clearly defined herein, should not be understood abnormally or as having an excessively formal definition.

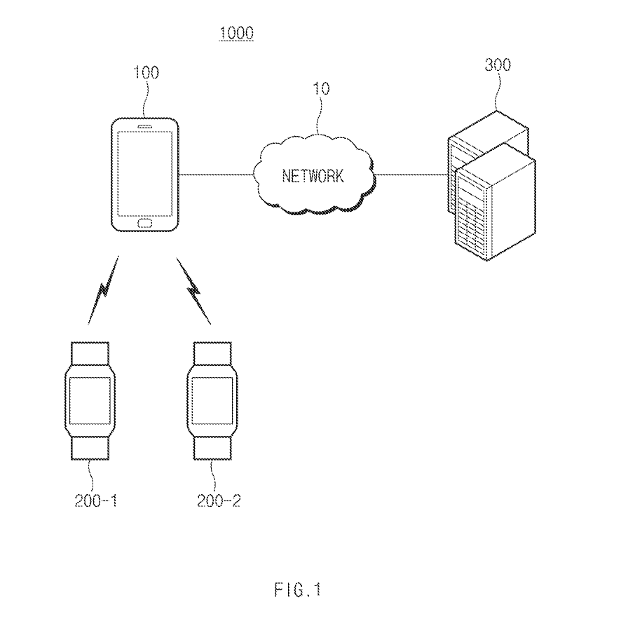

FIG. 1 is a diagram illustrating a configuration of an IP multimedia subsystem (IMS) system according to an embodiment of the present invention.

Referring to FIG. 1, an IMS system 1000 includes a main electronic device 100, at least one sub electronic device (e.g., a first sub electronic device 200-1 or a second sub electronic device 200-2), and an IMS server 300.

According to an embodiment of the present invention, the main electronic device 100 may be an electronic device (e.g., a smartphone, a smart TV, an AP, etc.) connectable to an internet network or a mobile communication network. According to an embodiment of the present invention, the sub electronic device (e.g., the first sub electronic device 200-1 or the second sub electronic device 200-2) may be a user wearable electronic device.

The main electronic device 100 and the sub electronic device (e.g., the first sub electronic device 200-1 or the second sub electronic device 200-2) are connected to each other and communicate with each other. According to an embodiment of the present invention, the main electronic device 100 and the sub electronic device may be connected to each other through short range wireless communication techniques, such as Bluetooth, WiFi, etc.

The main electronic device 100 is connected to the IMS server 300 via the network 10. According to an embodiment of the present invention, the network 10 may be a mobile communication network (e.g., long-term evolution (LTE), third generation (3G), etc.) or an internet network.

In order to use IMS service, a process for registering an electronic device in the IMS server 300 is required. Accordingly, the main electronic device 100 or the sub electronic device (e.g., the first sub electronic device 200-1 or the second sub electronic device 200-2) may register, in the IMS server 300, information such as public ID (PUID), private ID (PRID), instance-ID, reg-ID, IP address or call reception priority (e.g., a q-value),etc. The Mobile Station International Subscriber Directory Number (MSISDN) of the main electronic device 100 or the sub electronic device may be used as PUID in IMS registration information. The International Mobile Station Equipment Identity (IMEI) of the main electronic device 100 or the sub electronic device may be used as instance ID. The q-value, as information indicating an IMS call reception priority, may have a value of 0.0 to 1.0. The q-value of the main electronic device 100 or the sub electronic device may be set according to a user setting or set automatically according to a state of an electronic device.

According to an embodiment of the present invention, even when the sub electronic device (e.g., the first sub electronic device 200-1 or the second sub electronic device 200-2) is independently capable of being registered to the IMS server 300 (e.g., such as when the sub electronic device includes a communication module communicable with the IMS server 300, and the sub electronic device includes an IMS stack), the main electronic device 100 registers the sub electronic device to the IMS server 300 on behalf of the sub electronic device while the sub electronic device is connected to the main electronic device 100. In order to perform this registration, the main electronic device 100 receives information necessary for IMS service registration from the sub electronic device. The main electronic device 100 registers the sub electronic device in the IMS server 300 by using the IMS registration information received from the sub electronic device.

According to an embodiment of the present invention, when registering the sub electronic device (e.g., the first sub electronic device 200-1 or the second sub electronic device 200-2) in the IMS server 300, the main electronic device 100 may register the IP address of the main electronic device 100 as the IP address of the sub electronic device.

When a plurality of electronic devices having the same PUID are registered in the IMS server 300, the IMS server 300 may set the GRUU of an electronic device to identify each electronic device, and may then transmit the set GRUU to the electronic device. The IMS server 300 may set a GRUU on the basis of the instance-ID (e.g., an IMEI) of an electronic device. For example, when the PUIDs of the main electronic device 100 and the sub electronic device (e.g., the first sub electronic device 200-1 or the second sub electronic device 200-2) are the same, the GRUU of the main electronic device 100 may be set to 1 and the GRUU of the sub electronic device 20 may be set to 5.

If IMS service such as voice over IP (VoIP) or message transmission is requested from a specific PUID, the IMS server 300 may transmit an IMS call to the IP address of an electronic device having a corresponding PUID by checking IMS registration information. If there are a plurality of electronic devices having the same PUID, the destination of the IMS call may be determined according to a call reception priority (e.g., a q-value).

According to an embodiment of the present invention, the IMS system 1000 may include a plurality of main electronic devices 100. The sub electronic device (e.g., the first sub electronic device 200-1 or the second sub electronic device 200-2) may be connected one of the plurality of main electronic devices 100 and may be registered to the IMS server 300 through the connected main electronic device 100.

According to an embodiment of the present invention, the plurality of main electronic devices 100 may have priorities set according to a location or another set condition. The sub electronic device (e.g., the first sub electronic device 200-1 or the second sub electronic device 200-2) may be connected to one of the plurality of main electronic devices 100 and may be registered to the IMS server 300 through the connected main electronic device 100. For example, if the sub electronic device is located outside an office or a home, a smartphone may be set to have a priority and if the sub electronic device is located inside an office or a home, an Access Point (AP) may be set to have a priority.

If the sub electronic device (e.g., the first sub electronic device 200-1 or the second sub electronic device 200-2) is disconnected from an existing main electronic device and connected to a new main electronic device, an existing main electronic device may cancel the IMS registration of the sub electronic device and the newly connected main electronic device may register the sub electronic device in the IMS server 300 again.

According to an embodiment of the present invention, the IMS system 1000 may include a plurality of sub electronic devices 200-1 and 200-2. Each of the plurality of sub electronic devices 200-1 and 200-2 may be connected to the main electronic device 100 via network. The main electronic device 100 may register each of the plurality of sub electronic devices 200-1 and 200-2 in the IMS server 300.

When the plurality of sub electronic devices 200-1 and 200-2 connected to the main electronic device 100 are registered in the IMS server 300 with the same PUID as a main electronic device, an IMS call may be transmitted according to a call reception priority of each of the plurality of sub electronic devices 200-1 and 200-2 set during an IMS registration process. For example, if the q-value of a main electronic device is 0.5, the q-value of a first sub electronic device 200-1 is 1.0, and the q-value of a second sub electronic device 200-2 is 0.1, the destination of an IMS call may be the first sub electronic device.

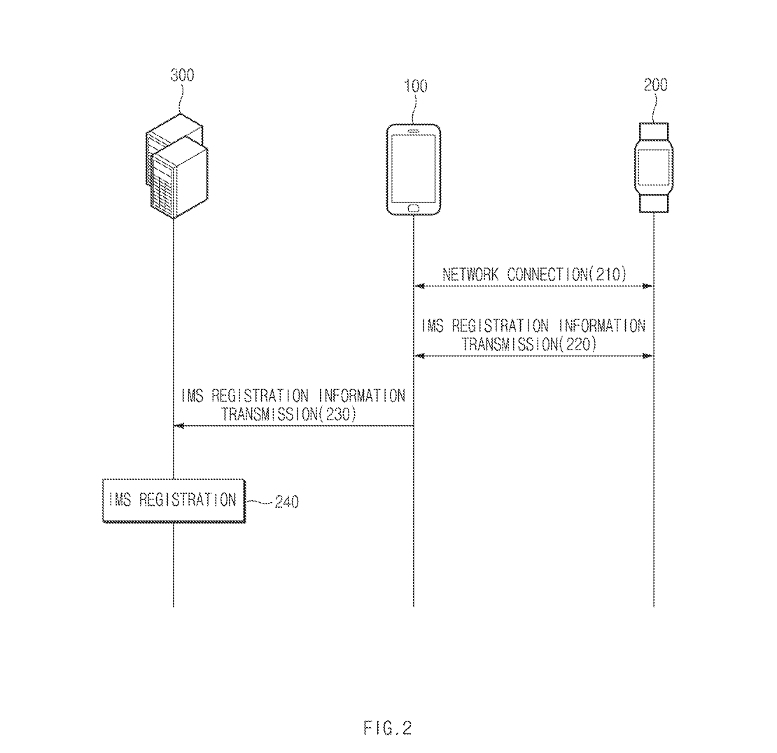

An operation of the IMS system 1000 is described as follows with reference to FIGS. 2 to 5 according to an embodiment of the present invention.

FIG. 2 is a diagram illustrating an IMS service providing method of an IMS system according to an embodiment of the present invention. More specifically, FIG. 2 is a diagram illustrating an operation in which the main electronic device 100 registers the sub electronic device 200 in IMS service.

Referring to FIG. 2, the main electronic device 100 and the sub electronic device 200 are connected to each other via network in step 210, and the sub electronic device 200 transmits the IMS registration information of the sub electronic device 200 to the main electronic device 100 in step 220. For example, the sub electronic device 200 may transmit at least one of the international mobile equipment identity (IMEI), mobile subscriber ISDN number (MSISDN), and international mobile station identity (IMSI) of the sub electronic device 200.

The main electronic device 100 may register the sub electronic device 200 in the IMS server 300 by using at least some of the IMS registration information of the sub electronic device 200. In step 230, the main electronic device 100 transmits the IMS registration information of the sub electronic device 200 to the IMS server 300 and in step 240, the IMS server 300 registers the sub electronic device 200.

The main electronic device 100 may transmit registration information such as the public ID (PUID), private ID (PRID), instance-ID, reg-ID, IP address, q-value, etc. of the sub electronic device 200 to the IMS server 300.

According to an embodiment of the present invention, when registering the sub electronic device 200 in the IMS server 300, the main electronic device 100 may set the IMS call reception priority (e.g., a q-value) of the sub electronic device 200 differently according to whether a user is wearing the sub electronic device 200. For example, if a user is wearing the sub electronic device 200, the IMS call reception priority of the sub electronic device 200 may be set higher than the call reception priority of the main electronic device 100 and if a user is not wearing the sub electronic device 200, the IMS call reception priority of the sub electronic device 200 may be set lower than the call reception priority of the main electronic device 100

According to an embodiment of the present invention, if the PUID of the sub electronic device 200 is identical to the PUID of the main electronic device 100, the IMS server 300 may set the GRUUs of the main electronic device 100 and the sub electronic device 200 and transmit the GRUUs to the main electronic device 100. According to an embodiment of the present invention, the IMS server 300 may set a GRUU on the basis of the instance-IDs (e.g., an IMEI) of the main electronic device 100 and the sub electronic device 200. The GRUU may be used to identify an electronic device using the same PUID (e.g., an MSISDN) in an IMS system.

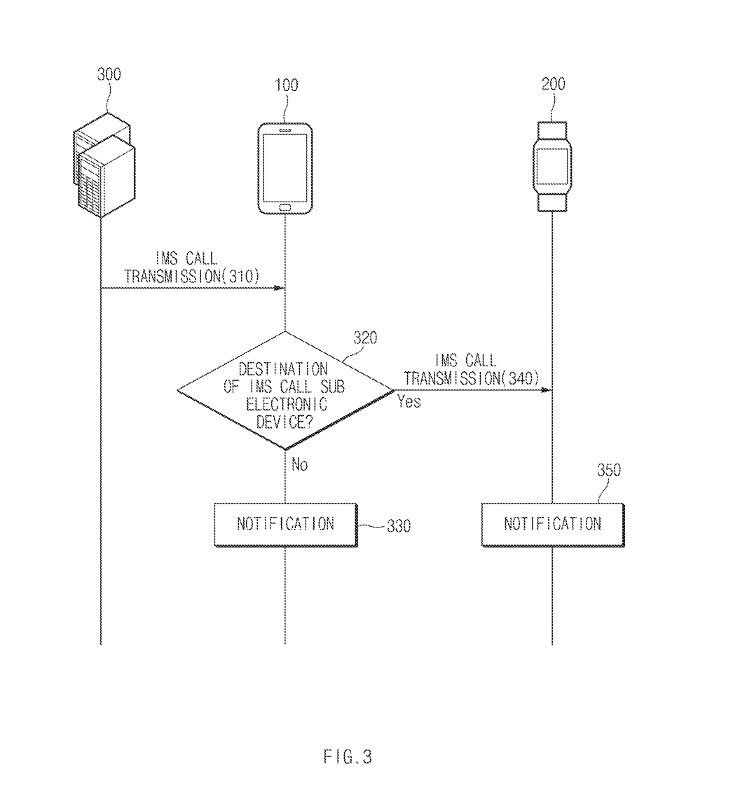

FIG. 3 is a diagram illustrating an IMS service providing method of an IMS system according to an embodiment of the present invention. More specifically, FIG. 3 is a diagram illustrating operations performed after the main electronic device 100 registers the sub electronic device 200 in the IMS server 300 and an IMS call occurs.

Referring to FIG. 3, the IMS system 310 transmits an IMS call to the main electronic device 100 in step 310. When the main electronic device 100 registers the sub electronic device 200 in IMS service, the IP address of the main electronic device 100 may be registered as the IP address of the sub electronic device 200. Accordingly, even if the destination of an IMS call is the sub electronic device 200, the IMS server 300 may transmit the IMS call to the main electronic device 100.

In step 320, the main electronic device 100 determines whether the destination of a received IMS call is a sub electronic device. According to an embodiment of the present invention, the main electronic device 100 may determine the destination of an IMS call by using the MSISDN (or PUID) or GRUU included in the received IMS call. For example, if the MSISDNs of the main electronic device 100 and the sub electronic device 200 are different from each other, the destination of an IMS call may be determined by checking the MSISDN included in the IMS call. As another example, if the MSISDNs of the main electronic device 100 and the sub electronic device 200 are the same, the destination of an IMS call may be determined by checking the GRUU included in the IMS call.

If it is determined that the destination of an IMS call is not a sub electronic device (i.e., it is determined that the destination of an IMS call is a main electronic device), the main electronic device 100 notifies a user that the IMS call is received in step 330.

If it is determined that the destination of an IMS call is a sub electronic device, the main electronic device 100 transmits the IMS call to the sub electronic device 200 in step 340.

When an IMS call is received from the main electronic device 100, the sub electronic device 200 notifies a user that the IMS call is received in step 350.

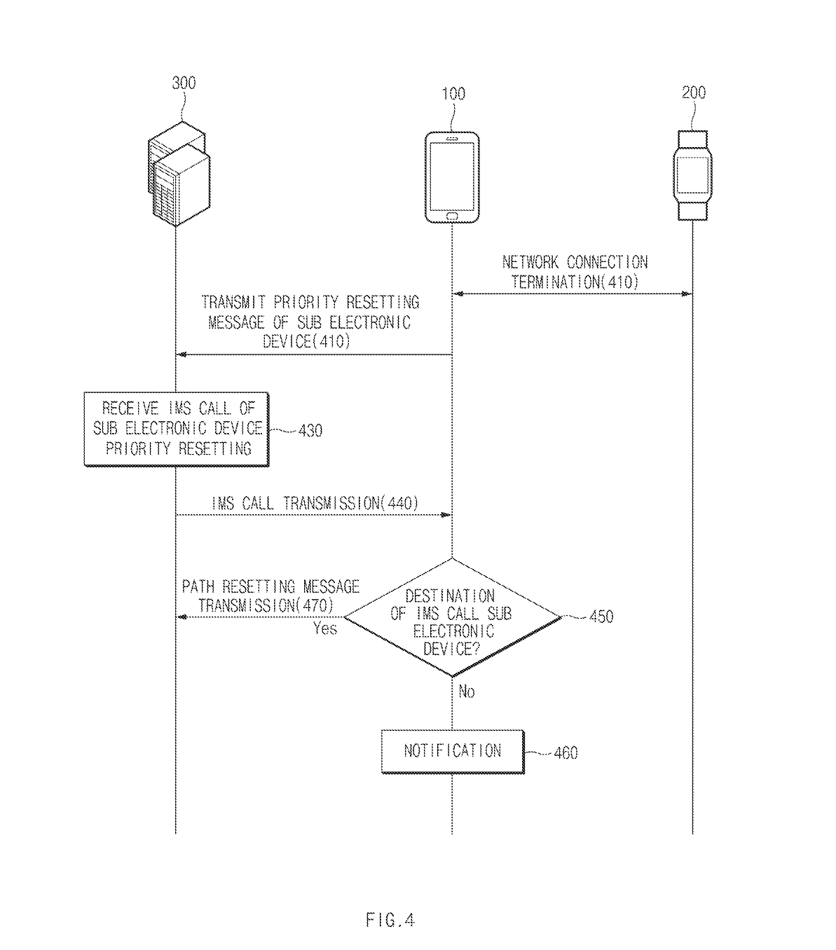

FIG. 4 is a diagram illustrating an IMS service providing method of an IMS system according to an embodiment of the present invention. More specifically, FIG. 4 is a diagram illustrating operations performed after the main electronic device 100 registers the sub electronic device 200 in the IMS server 300, if a network connection between the main electronic device 100 and the sub electronic device 200 is terminated and an IMS call occurs.

Referring to FIG. 4, the network connection between the main electronic device 100 and the sub electronic device 200 is terminated in step 410, and the main electronic device 100 transmits a call reception priority resetting message of the sub electronic device 200 to the IMS server 300 in step 420. For example, the main electronic device 100 may set the q-value of the sub electronic device 200 to be higher (or the highest among electronic devices having the same PUID) than when the network connection is terminated. In step 430, the IMS server 300 resets the IMS call reception priority of the sub electronic device 200 on the basis of a message received from the main electronic device 100. According to an embodiment of the present invention, when the call reception priority of the sub electronic device 200 is not required to be changed, steps 420 and 430 may be omitted.

In step 440, the IMS server 300 transmits an IMS call to the main electronic device 100. According to an embodiment of the present invention, even if the network connection between the main electronic device 100 and the sub electronic device 200 is terminated, the IP address of the sub electronic device 200 registered in the IMS server 300 may not be changed. Accordingly, even if the destination of an IMS call is the sub electronic device 200, the IMS server 300 may transmit the IMS call to the main electronic device 100.

In step 450, the main electronic device 100 determines whether the destination of a received IMS call is a sub electronic device. According to an embodiment of the present invention, the main electronic device 100 determines the destination of an IMS call by using the MSISDN or GRUU included in the received IMS call. For example, if the MSISDNs of the main electronic device 100 and the sub electronic device 200 are different from each other, the destination of an IMS call may be determined by checking the MSISDN included in the IMS call. As another example, if the MSISDNs of the main electronic device 100 and the sub electronic device 200 are the same, the destination of an IMS call may be determined by checking the GRUU included in the IMS call.

If it is determined that the destination of an IMS call is not a sub electronic device (i.e., it is determined that the destination of an IMS call is the main electronic device 100), the main electronic device 100 notifies a user of the main electronic device 100 that the IMS call is received in step 460.

If it is determined that the destination of an IMS call is a sub electronic device, the main electronic device 100 transmits a path resetting message to the IMS server 300 in step 470. According to an embodiment of the present invention, the path resetting message may include the MSISDN of the sub electronic device 200.

According to an embodiment of the present invention, the main electronic device 100 may determine whether the sub electronic device 200 has a communicable modem and whether an IMS stack is embedded in the sub electronic device 200. According to an embodiment of the present invention, if the sub electronic device 200 has a communicable modem, but is not capable of separately receiving an IMS call separately due to the lack of an IMS stack, the main electronic device 100 may transmit a path resetting message to the IMS server 300.

According to an embodiment of the present invention, the path resetting message may include a SIP Response value of 302 (Moved Temporarily) or 380 (Alternative Service), in order to implement path resetting.

When a path resetting message is received, the IMS server 300 may allow the sub electronic device 200 to receive a call through another path. For example, the IMS server 300 may transmit the MSISDN of the sub electronic device 200 to a circuit switch (not shown) in order to allow the sub electronic device 200 to receive a circuit switching (CS) call through the circuit switch.

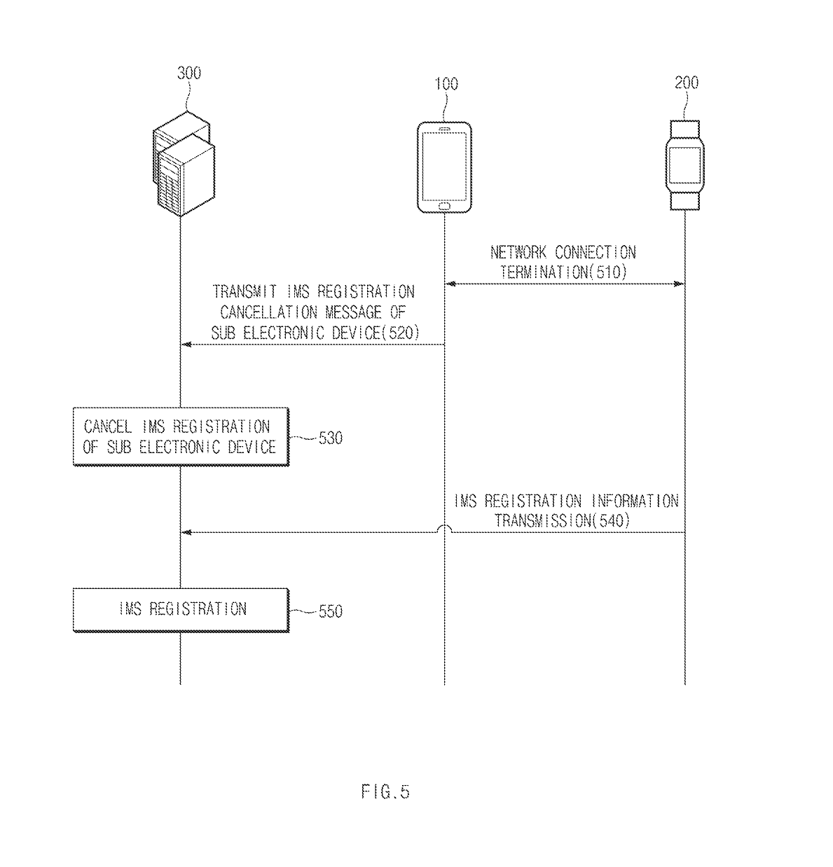

FIG. 5 is a diagram illustrating an IMS service providing method of an IMS system according to an embodiment of the present invention. More specifically, FIG. 5 is a diagram illustrating operations performed while the sub electronic device 200 has an additional IMS stack and a network connection between the main electronic device 100 and the sub electronic device 200 is terminated.

Referring to FIG. 5, the network connection between the main electronic device 100 and the sub electronic device 200 is terminated in step 510, and the main electronic device 100 transmits the IMS registration cancellation message of the sub electronic device 200 to the IMS server 300.

According to an embodiment of the present invention, the main electronic device 100 may determine whether the sub electronic device 200 has a communicable modem and an IMS stack is embedded. According to an embodiment of the present invention, if the sub electronic device 200 has a communicable modem and is capable of receiving an IMS call separately because there is an IMS stack, the main electronic device 100 may transmit an IMS registration cancellation message to the IMS server 300.

In step 530, the IMS server 300 cancels the IMS registration of the sub electronic device 200 on the basis of a message received from the main electronic device 100.

When the network connection between the sub electronic device 200 and the main electronic device 100 is terminated, the sub electronic device 200 transmits IMS registration information to the IMS server 300 in step 540. According to an embodiment of the present invention, unlike a process in which the sub electronic device 200 is registered to the IMS server 300 through the main electronic device 100, the IP address of the sub electronic device 200 may be registered. Accordingly, an IMS call to the sub electronic device 200, as a destination of the IMS call, may be directly transmitted to the sub electronic device 200 without passing through the main electronic device 100.

In step 550, the IMS server 300 registers the sub electronic device 200 by using the IMS registration information received from the sub electronic device 200.

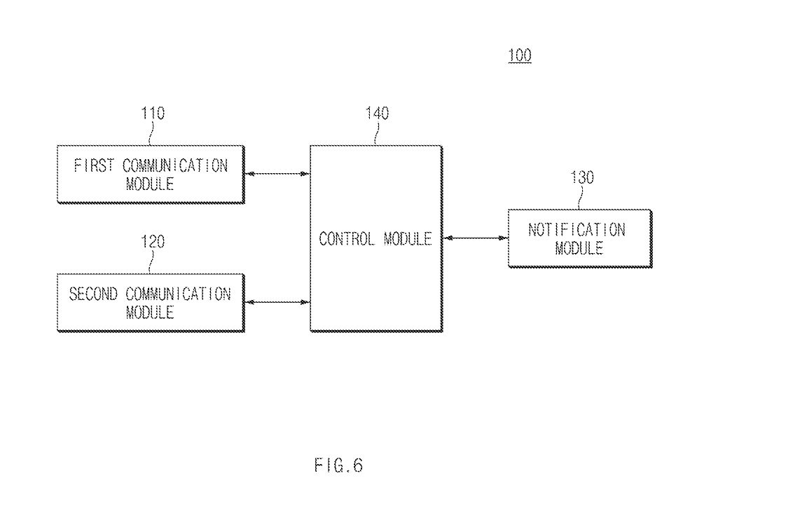

FIG. 6 is a block diagram illustrating a configuration of a main electronic device according to an embodiment of the present invention.

Referring to FIG. 6, according to an embodiment of the present invention, a main electronic device 100 includes a first communication module 110, a second communication module 120, a notification module 130, and a control module 140.

The first communication module 110 communicates with the sub electronic device 200. According to an embodiment of the present invention, the first communication module 110 may include a short range wireless communication module such as a near field communication (NFC) module, a Bluetooth module, a WiFi module, etc.

Since description relating to the communication with the sub electronic device 200 among descriptions for the main electronic device 100 of the IMS system described with reference to FIGS. 1 to 5 is applicable to the first communication module 110, overlapping description is omitted.

According to an embodiment of the present invention, the first communication module 110 may receive the IMS registration information of the sub electronic device 200 from the sub electronic device 200.

The second communication module 120 communicates with the IMS server 300. According to an embodiment of the present invention, the second communication module 120 may perform communication with the IMS server 300 via an Internet network or a mobile communication network.

Communications between the IMS server 300 and the main electronic device 100 of the IMS system are already described herein above with reference to FIGS. 1 to 5 are applicable to the second communication module 120, and therefore a further description of such communications is omitted for clarity and conciseness.

When an IMS call to the main electronic device 100, as a destination of the IMS call, is received from the IMS server 300, the notification module 130 may notify a user of the reception fact of the IMS call. According to an embodiment of the present invention, the notification module 130 may notify a user of the IMS call reception fact through vibration, display screen, and sound. For this, the notification module 130 may include a display, a speaker, a vibration motor, etc.

The control module 140 controls overall operations of the main electronic device 100. The control module 140 may provide IMS service to a user according to an embodiment of the present invention by controlling each of the first communication module 110, the second communication module 120, and the notification module 130.

According to an embodiment of the present invention, if the IMS registration information of the sub electronic device 200 is received from the sub electronic device 200, the control module 140 may control registration of the sub electronic device 200 in the IMS server 300 by using at least some of the IMS registration information of the sub electronic device 200. The control module 140 may control registration of the sub electronic device 200 in the IMS server 300 by transmitting the IMS registration information of the sub electronic device 200 to the IMS server 300 through the second communication module 120. For example, the control module 140 may control transmission of registration information such as the PUID, PRID, instance-ID, reg-ID, IP address, q-value, etc. of the sub electronic device 200 to the IMS server 300.

According to an embodiment of the present invention, the control module 140 may control registration of an IP address among the IMS registration information of the sub electronic device 200 as the IP address of a main electronic device. Accordingly, an IMS call to the sub electronic device 200, as a destination of the IMS call, may be received by the main electronic device 100 instead of the sub electronic device 200.

According to an embodiment of the present invention, when registering the sub electronic device 200 in the IMS server 300, the control module 140 may set the IMS call reception priority (e.g., a q-value) of the sub electronic device 200 differently according to whether a user is wearing the sub electronic device 200. For example, if a user is wearing the sub electronic device 200, the IMS call reception priority of the sub electronic device 200 may be set higher than the call reception priority of the main electronic device 100 and if a user is not wearing the sub electronic device 200, the IMS call reception priority of the sub electronic device 200 may be set lower than the call reception priority of the main electronic device 100. A user wearing state of the sub electronic device 200 may be received from the sub electronic device 200.

According to an embodiment of the present invention, if the network connection of the sub electronic device 200 is terminated, the control module 140 may change the IMS call reception priority of the sub electronic device 200 and register the changed IMS call reception priority of the sub electronic device 200. For example, the control module 140 may control transmission of a call reception priority resetting message of the sub electronic device 200 to the IMS server 300. Accordingly, the IMS call reception priority of the sub electronic device 200 may be changed in the IMS server 300.

According to an embodiment of the present invention, if the network connection of the sub electronic device 200 is terminated, the control module 140 may cancel the IMS registration of the sub electronic device 200. For example, the control module 140 may control transmission of the IMS registration cancellation message of the sub electronic device 200 to the IMS server 300.

According to an embodiment of the present invention, if the sub electronic device 200 has an additional communicable modem and is capable of receiving an IMS call separately because an IMS stack is embedded, the control module 140 may transmit an IMS registration cancellation message to the IMS server 300.

According to an embodiment of the present invention, if an IMS call is received from the IMS server 300, the control module 140 may determine whether the destination of the received IMS call is a sub electronic device. According to an embodiment of the present invention, the control module 140 may determine the destination of the IMS call by using the MSISDN or GRUU included in the received IMS call. For example, if the MSISDNs of the main electronic device 100 and the sub electronic device 200 are different from each other, the destination of an IMS call may be determined by checking the MSISDN included in the IMS call. As another example, if the MSISDNs of the main electronic device 100 and the sub electronic device 200 are the same, the destination of an IMS call may be determined by checking the GRUU included in the IMS call.

If it is determined that the destination of an IMS call is not a sub electronic device (e.g., it is determined that the destination of an IMS call is a main electronic device), the control module 140 may notify a user that the IMS call is received. If it is determined that the destination of an IMS call is a sub electronic device, the control module 140 may control transmission of the IMS call to the sub electronic device 200.

According to an embodiment of the present invention, while the network connection of the sub electronic device 200 is terminated, if an IMS call to the sub electronic device 200, as a destination of the IMS call, is received, the control module 140 may control transmission of a path resetting message to the IMS server 300. According to an embodiment of the present invention, the path resetting message may include the MSISDN of the sub electronic device 200.

According to an embodiment of the present invention, the control module 140 may determine whether the sub electronic device 200 has an additional communicable modem and an IMS stack is embedded on the basis of information received from the sub electronic device 200. If the sub electronic device 200 has an additional communicable modem and is not capable of receiving an IMS call separately due to no IMS stack, the control module 140 may control transmission of a path resetting message to the IMS server 300.

According to an embodiment of the present invention, the path resetting message may include a SIP Response value of 302 (Moved Temporarily) or 380 (Alternative Service) in order for path resetting.

If the path resetting message is transmitted to the IMS server 300, the IMS server 300 may allow the sub electronic device 200 to receive a call through another path. For example, the IMS server 300 may transmit the MSISDN of the sub electronic device 200 to a circuit switch in order to allow the sub electronic device 200 to receive a CS call through the circuit switch.

A main electronic device according to an embodiment of the present invention may include a first communication module communicating with a sub electronic device, a second communication module for communicating with an IMS server, and a control module for registering the sub electronic device in the IMS server by using at least some of the IMS registration information of the sub electronic device when the IMS registration information of the sub electronic device is received from the sub electronic device.

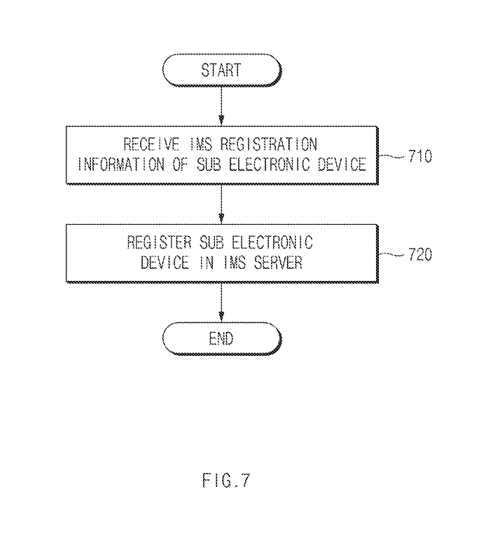

FIG. 7 is a flowchart illustrating an IMS service providing method of a main electronic device according to an embodiment of the present invention. The method described with reference to the flowchart shown in FIG. 7 may be re-configured to perform operations processed by the main electronic device shown in FIG. 6. Accordingly, even if some of the operations described with reference to FIG. 6 are omitted from the following description with reference to FIG. 7, the operations performed by the electronic device shown in FIG. 6 may nonetheless be applied to method described with reference to the flowchart shown in FIG. 7.

Referring to FIG. 7, the main electronic device 100 receives the IMS registration information of the sub electronic device 200 from the sub electronic device 200 in step 710.

In step 720, the main electronic device 100 registers the sub electronic device 200 in the IMS server 300 by using at least some of the IMS registration information of the sub electronic device 200.

The main electronic device 100 may register the sub electronic device 200 in the IMS server 300 by transmitting the IMS registration information of the sub electronic device 200 to the IMS server 300. For example, the main electronic device 100 may transmit registration information such as the PUID, PRID, instance-ID, reg-ID, IP address, q-value, etc. of the sub electronic device 200 to the IMS server 300.

According to an embodiment of the present invention, the main electronic device 100 may register an IP address among the IMS registration information of the sub electronic device 200 as the IP address of the main electronic device 100. Accordingly, an IMS call to the sub electronic device 200, as a destination of the IMS call, may be received by the main electronic device 100 instead of the sub electronic device 200.

According to an embodiment of the present invention, when registering the sub electronic device 200 in the IMS server 300, the main electronic device 100 may set the IMS call reception priority (e.g., a q-value) of the sub electronic device 200 differently according to whether a user is wearing the sub electronic device 200.

According to an embodiment of the present invention, when registering the sub electronic device 200 in the IMS server 300, the main electronic device 100 may set the IMS call reception priority (e.g., a q-value) of the sub electronic device 200 differently according to whether a user is wearing the sub electronic device 200.

According to an embodiment of the present invention, if the network connection of the sub electronic device 200 is terminated, the main electronic device 100 may change and resister the IMS call reception priority of the sub electronic device 200.

According to an embodiment of the present invention, if the network connection of the sub electronic device 200 is terminated, the main electronic device 100 may cancel the IMS registration of the sub electronic device 200.

According to an embodiment of the present invention, if an IMS call is received from the IMS server 300, the main electronic device 100 may determine whether the destination of the received IMS call is a sub electronic device. According to an embodiment of the present invention, the main electronic device 100 may determine the destination of an IMS call by using the MSISDN or GRUU included in the received IMS call.

According to an embodiment of the present invention, if it is determined that the destination of an IMS call is not a sub electronic device (e.g., it is determined that the destination of an IMS call is a main electronic device), the main electronic device 100 may notify a user that the IMS call is received. If it is determined that the destination of an IMS call is a sub electronic device, the main electronic device 100 may transmit the IMS call to the sub electronic device 200.

According to an embodiment of the present invention, while the network connection between the first communication module 110 and the sub electronic device 200 is terminated, if an IMS call to the sub electronic device 200, as a destination of the IMS call, is received, the main electronic device 100 may transmit a path resetting message to the IMS server 300. According to an embodiment of the present invention, the path resetting message may include the MSISDN of the sub electronic device 200. According to an embodiment of the present invention, the path resetting message may include a SIP Response value of 302 (Moved Temporarily) or 380 (Alternative Service) in order for path resetting.

According to an embodiment of the present invention, the main electronic device 100 may determine whether an IMS stack is embedded in the sub electronic device 200 on the basis of information received from the sub electronic device 200. If the IMS stack is embedded in the sub electronic device 200, the main electronic device 100 may transmit a path resetting message to the IMS server 300.

An IMS service providing method of a main electronic device according to an embodiment of the present invention may include receiving the IMS registration information of a sub electronic device from the sub electronic device and registering the sub electronic device in an IMS server by using the IMS registration information of the sub electronic device.

The IMS service providing method of the main electronic device according to the above-mentioned an embodiment of the present invention may be implemented with a program executable on an electronic device. Then, such a program may be stored in various types of recording media and used.

According to an embodiment of the present invention, even when there are limitations in using IMS service independently through a wearable electronic device, the IMS service may be provided through a main electronic device.

According to an embodiment of the present invention, an appropriate IMS service may be provided according to a user's location, a situation, and an electronic device's performance or state.

In more detail, program code for performing the above methods may be stored in various types of nonvolatile recording media such as flash memory, read only memory (ROM), erasable programmable ROM (EPROM), electronically erasable and programmable ROM (EEPROM), a hard disk, a removable disk, a memory card, universal serial bus (USB) memory, and compact disc (CD)-ROM.

Although an embodiment of the present invention have been particularly shown and described, embodiments of the present invention are not limited to the above-mentioned specific embodiments and it should be understood by those skilled in the art that various modified embodiments are possible without departing from the spirit and scope of the present invention as defined by the appended claims and their equivalents.

What is claimed is:

1. A main electronic device comprising:
a first communication module configured to communicate with a sub electronic device;
a second communication module configured to communicate with an internet protocol (IP) multimedia subsystem (IMS) server; and
a control module configured to control receipt of IMS registration information from the sub electronic device and registration of the sub electronic device in the IMS server by using at least some of the received IMS registration information of the sub electronic device.

2. The main electronic device of claim 1, wherein the control module is further configured to control registration of an IP address of the main electronic device as an IP address of the sub electronic device in the IMS server.

3. The main electronic device of claim 1, wherein the control module is further configured to control registration of an IMS call reception priority of the sub electronic device differently in the IMS server according to whether a user is wearing the sub electronic device.

4. The main electronic device of claim 1, wherein, when a network connection with the sub electronic device is disconnected, the control module is further configured to control deregistration of the IMS registration of the sub electronic device from the IMS server.

5. The main electronic device of claim 1, wherein, when a connection with the sub electronic device is terminated, the control module is further configured to control change of an IMS call reception priority of the sub electronic device and registration of the changed IMS call reception priority of the sub electronic device in the IMS server.

6. The main electronic device of claim 1, wherein, when an IMS call to the sub electronic device, as a destination of the IMS call, is received from the IMS server, the control module is further configured to control delivery of the IMS call to the sub electronic device.

7. The main electronic device of claim 1, wherein, when an IMS call to the sub electronic device, as a destination of the IMS call, is received during a state in which a network connection with the sub electronic device is terminated, the control module is further configured to control transmission of a path resetting message to the IMS server to allow the sub electronic device to receive a call through another path.

8. An internet protocol (IP) multimedia subsystem (IMS) service providing method of a main electronic device, the method comprising:
receiving, from a sub electronic device, IMS registration information of the sub electronic device; and
registering, in an IMS server, the sub electronic device by using at least some of the received IMS registration information of the sub electronic device.

9. The method of claim 8, wherein registering the sub electronic device in the IMS server comprises registering an IP address in the IMS registration information of the main electronic device as an IP address of the sub electronic device.

10. The method of claim 8, wherein registering the sub electronic device in the IMS server comprises registering an IMS call reception priority of the sub electronic device differently according to whether a user is wearing the sub electronic device.

11. The method of claim 8, further comprising deregistering, when a network connection with the sub electronic device is disconnected, the IMS registration of the sub electronic device.

12. The method of claim 8, further comprising changing, when a connection with the sub electronic device is terminated, an IMS call reception priority of the sub electronic device, and registering the changed IMS call reception priority of the sub electronic device in the IMS server.

13. The method of claim 8, further comprising delivering, when an IMS call to the sub electronic device, as a destination of the IMS call, is received from the IMS server, the IMS call to the sub electronic device.

14. The method of claim 8, further comprising transmitting, when an IMS call to the sub electronic device, as a destination of the IMS call, is received during a state in which a network connection with the sub electronic device is terminated, a path resetting message to the IMS server to allow the sub electronic device to receive a call through another path.

15. A non-transitory computer readable recording medium having a program thereon to execute an internet protocol (IP) multimedia subsystem (IMS) service providing method of a main electronic device, the method comprising:
receiving, from a sub electronic device, IMS registration information of the sub electronic device; and
registering, in an IMS server, the sub electronic device by using at least some of the IMS registration information of the sub electronic device.

16. The non-transitory computer readable recording medium of claim 15, wherein registering the sub electronic device in the IMS server comprises registering an IP address in the IMS registration information of the main electronic device as an IP address of the sub electronic device.

17. The non-transitory computer readable recording medium of claim 15, wherein registering the sub electronic device in the IMS server comprises registering an IMS call reception priority of the sub electronic device differently according to whether a user is wearing the sub electronic device.

18. The non-transitory computer readable recording medium of claim 15, further comprising deregistering, when a network connection with the sub electronic device is disconnected, the IMS registration of the sub electronic device.

19. The non-transitory computer readable recording medium of claim 15, further comprising changing, when a connection with the sub electronic device is terminated, an IMS call reception priority of the sub electronic device, and registering the changed IMS call reception priority of the sub electronic device in the IMS server.

20. The non-transitory computer readable recording medium of claim 15. further comprising delivering, when an IMS call to the sub electronic device, as a destination of the IMS call, is received from the IMS server, the IMS call to the sub electronic device.
